(19) United States
(12) Patent Application Publication
(10) Pub. No.: US 2009/0053684 A1
(43) Pub. Date: Feb. 26, 2009

(54) Seatbelt demonstration kit and method for teaching proper seatbelt usage

(75) Inventor: James Michael Bosley, Edmond, OK (US)

Correspondence Address: DUNLAP CODDING, P.C., PO BOX 16370, OKLAHOMA CITY, OK, 73113, US

(73) Assignee: Beam's Industries, Inc.

(21) Appl. No.: 11/895,109

(22) Filed: Aug. 23, 2007

(51) Int. Cl. G09B 25/00

(52) U.S. Cl. 434/373

(57) ABSTRACT

A seatbelt kit for demonstrating and educating proper seatbelt usage to at least one individual. The seatbelt kit includes at least one retractor, at least one latch plate, at least one segment of webbing and at least one seatbelt buckles The kit also includes a manual for instructing at least one individual on the proper usage of at least one seatbelt component provided in the seatbelt demonstration kit. A method for educating the at least one individual on proper usage of a seatbelt is disclosed.

### CROSS REFERENCE TO RELATED APPLICATIONS

Not applicable.

### BACKGROUND OF THE INVENTION

1. Field of the Invention

The present invention relates generally to an educational kit for teaching seatbelt safety, and more particularly, not by way of limitation, to an improved method and demonstration kit having various seat belt components for educating individuals on the proper use of a seat belt.

2. Brief Description of the Prior Art

Vehicle occupant protection systems provide various features built into a vehicle to protect an occupant(s). One such feature provided in a vehicle is a seatbelt. Many individuals, adults and children, do not know the proper way to use the seatbelt. This is particularly true with the use and installation of a child safety seat in a vehicle. Various educational aids help to impart subject matter to individuals seeking to learn a particular topic. A variety of methods and devices have been used for teaching seatbelt safety. It is to such an improved seatbelt demonstration kit and method of using the kit to educate individuals on the proper use of a seatbelt that the present invention is directed.

### BRIEF DESCRIPTION OF THE SEVERAL VIEWS OF THE DRAWINGS

FIG. 1 is a perspective view of a seatbelt demonstration kit constructed in accordance with the present invention.

### DETAILED DESCRIPTION OF THE INVENTION

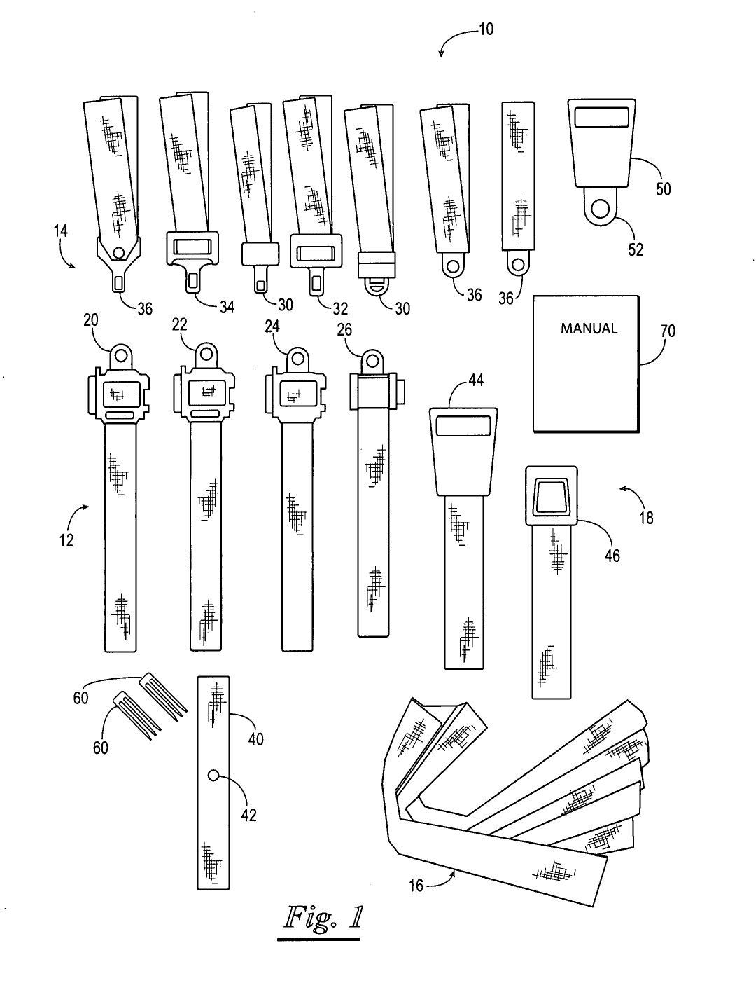

Referring now to the drawings, and more particularly to FIG. 1, shown therein is a seatbelt demonstration kit 10 constructed in accordance with the present invention. The seatbelt demonstration kit 10 enables a facilitator to teach at least one individual the proper usage of a seatbelt for child passenger safety installation or individual use. The seatbelt demonstration kit 10 includes conventional seatbelt materials and components found in vehicles. Each of the conventional seatbelt materials and components is known to one of ordinary skill in the art, thus no further description of the conventional seatbelt materials and components in the seatbelt demonstration kit 10 is believed necessary. Also, due to the seatbelt demonstration kit 10 having multiple components, it should be understood that the seatbelt demonstration kit 10 may be easily hand carried in a bag or some other container for carrying articles.

The seatbelt demonstration kit 10 includes at least one retractor 12, at least one latch plate 14, at least one segment of webbing 16 and at least one seatbelt buckle 18. Although, certain seatbelt materials and components which may be utilized are shown as being materials and components of the seatbelt demonstration kit 10, it should be understood by one of ordinary skill in the art that a variety of different seatbelt materials and components in a variety of different combinations may be utilized in the seatbelt demonstration kit 10 without departing from the invention concept of the present invention as long as such seatbelt materials and components permit the facilitator to teach one or more individuals as to the proper use of a seatbelt.

The at least one retractor 12 may be a vehicle sensitive emergency locking retractor (ELR) 20, a webbing sensitive ELR 22, a switchable retractor 24 and an automatic locking retractor (ALR) 26. The vehicle sensitive ELR 20 is the most common type of ELR in use today. It locks only when the vehicle changes velocity quickly as in a sudden stop, deceleration, rollover or sharp turn, for example.

The webbing sensitive ELR 22 is no longer allowed in new vehicle production. It is only found in older-model cars. The webbing sensitive retractor 22 only locks when the webbing is pulled quickly from the retractor. Many older vehicles include vehicle sensitive retractors which have a webbing sensitive mechanism built in as a secondary locking feature.

The switchable retractor (convertible ALR/ELR) 24 is a combination of a vehicle sensitive ELR and an ALR. These retractors are designed to serve both adult and child safety seats using the same belt.

The ALR 26 allows webbing to be extracted in one motion. Once the motion stops, the webbing is locked and cannot be extended further without first allowing it to fully retract. The ALR 26 acts as a ratchet, recoiling slack and preventing further extension of the webbing.

A different color of webbing, such as red, blue, green, orange, yellow, etc., may be provided with various types of retractors 12 in order to distinguish the type of retractor being identified. For example, a vehicle sensitive ELR 20 may have a red webbing, a webbing sensitive ELR 22 may have a blue webbing, a switchable retractor 24 may be provided with a green webbing and an ALR 26 may have a black webbing.

The at least one latch plate 14 may include, but is not limited to, a first locking latch plate 30, a second locking latch plate 32, a sliding latch plate 34, a fixed latch plate or sewn-on latch plate 36 or a switchable latch plate (not shown). Although the various latch plates are shown included in the seatbelt demonstration kit 10, it should be understood that any latch plate known to one of ordinary skill in the art may be used in the seatbelt demonstration kit 10.

The first locking latch plate 30 holds a lap seatbelt snug after it has been adjusted. The first locking latch plate 30 contains a metal bar on the underside of the hardware that locks the seatbelt in position. The first locking latch plate 30 is generally, but not always, found in middle seat positions in a vehicle and works well with child safety seats. The first locking latch plate 30 locks when the webbing of the seatbelt is parallel or substantially parallel as possible to the first locking latch plate 30. The first locking latch plate 30 has a tilt-lock adjustment which locks the webbing of the seatbelt at an angle of not less than 30° between the base of the buckle and the anchor webbing. Webbing is included with the latch plates 14 to allow demonstration of locking characteristics of the various latch plates 14.

The second locking latch plate 32 is a lighter weight version of the first locking latch plate 30 and is found on lap and shoulder seatbelts.

The sliding latch plate 34 slides freely along the webbing, whether or not the seatbelt is buckled or not; and the webbing is disposed substantially parallel to the sliding latch plate 34. This type of latch plate 34 is found only on lap and shoulder belts. It relies on a retractor for locking the seatbelt tightly during a crash or sudden stop. Since the sliding latch plate 34 slides freely on the webbing, it requires the use of a locking clip when used with child safety seats or restraints.

The sewn-on latch plate or fixed latch plate 36 is a latch plate supported on a lap belt or a lap and shoulder belt, and the fixed latch plate 36 is permanently stitched on the seatbelt webbing. A detachable upper-torso restraint and fixed latch plate 36 is included in the seatbelt demonstration kit 10. This type of latch plate combination is occasionally found on vans and a variety of similar vehicles. The upper-torso restraint can be detached from the lap belt, thus allowing the lap belt to be used independently of the upper-torso restraint.

The switchable latch plate is normally a sliding latch plate 34 when used for adults, but it can be switched to lock around a child safety seat. The switchable latch plate has a button that slides sideways on the back of the latch plate.

The at least one segment of webbing 16 is the fabric of the seatbelt, which secures the occupant to a vehicle. The at least one segment of webbing 16 is included in the seatbelt demonstration kit 10 to allow locking clip practice for at least one individual being taught the proper use of seatbelts for child passenger seat installation. Thus, a plurality of segments of webbing may be provided for teaching a plurality of individuals the proper use of seatbelts. Additionally, at least one segment of webbing 40 is provided with a web-stop button 42. The web-stop button 42 keeps the associated latch plate 14 from sliding to the floor of the vehicle.

The at least one seatbelt buckle 18 in the seatbelt demonstration kit 10 is shown in FIG. 1 as three different types of buckles, namely 44, 46, and 50. Other various buckles may be side-release, top-release, or end-release style seatbelt buckles. However, it should be understood that other types of buckles may be used in accordance with the present invention provided such other types of buckles function in the proper usage of a seatbelt. Two of the buckles 44 and 46 have connected webbing 48 and the third buckle 50 is provided with a metal bracket 52. The buckle 50 is the most common style of buckle used in newer cars. These buckles are found in an almost infinite variety of lengths and bends. Additionally, many vehicles have buckles which have an electrical connection that turns off the seatbelt warning tone when the latch plate is engaged in the buckle.

In addition, at least one webbing clip 60 may be provided in the seatbelt demonstration kit 10 to hold webbing out of at least one retractor 12 while demonstrating a belt shortening clip.

Further, the seatbelt demonstration kit 10 may be provided with a manual (not shown) which defines and describes each seatbelt component included in the seatbelt demonstration kit 10 as well as their purpose and proper use. Further, the manual includes recommended methods to instruct an individual on the proper safe usage of a seatbelt. The manual may be provided in a print or an electronic format.

Optional components that may be included in the seatbelt demonstration kit 10 include, but are not limited to, a three-point seatbelt assembly having a webbing sensitive retractor, a three-point seatbelt assembly having a switchable retractor, a two-point seatbelt assembly having an ALR, a D-ring height adjuster and any variety of other seatbelt components known to one of ordinary skill in the art.

In use, a facilitator describes each seatbelt component included in the seatbelt demonstration kit 10 and instructs at least one individual on the proper usage of each seatbelt component. When describing certain components in the seatbelt demonstration kit 10, there are certain instructions which may help make the demonstration easier for the facilitator. For example, the vehicle sensitive ELR 20 has a specific mounting angle. The vehicle sensitive ELR 20 must be mounted at approximately a 90° angle relative to a support structure to extract the webbing segment vertically up and perpendicular to the floor. The easiest way to demonstrate the vehicle sensitive ELR 20 to at least one individual is to mount the vehicle sensitive ELR 20 against the vertical edge of a table, file cabinet, door, wall, etc., or use the included stand for such a purpose. This enables a facilitator to demonstrate the vehicle sensitive ELR 20 effectively using only the hands of the facilitator. It should be understood that if the vehicle sensitive ELR 20 tilts more than about a 15° angle from a vertical position in either direction, the vehicle sensitive ELR 20 will be in a locked condition. If the webbing segment does not release from the vehicle sensitive ELR 20, then the facilitator must grasp the webbing segment close to the vehicle sensitive ELR 20 and while holding the vehicle sensitive ELR 20 firmly with one hand at a 90° angle, pull the webbing segment with enough force to extend ½″ of webbing segment off a spool of the vehicle sensitive ELR 20. The webbing segment will slowly release, allowing it to retract ½″ or more onto the spool, unlocking the ELR 20. The spool of the ELR 20 may also be manually rotated to roll up more of the webbing segment. After the ELR 20 is unlocked, the facilitator can pull 24″ to 30″ of the webbing segment off the spool, and the webbing clip 28 may be used to hold the webbing segment in position. Unlocking the locked ELR 20 allows the ELR 20 to recoil approximately ½″ or more of the webbing segment which disengages an internal locking mechanism of the ELR 20.

The switchable retractor 24 must also be mounted at about a 90° angle relative to a support structure to extract the webbing segment of a seatbelt. The ELR is converted to the ALR by extending the webbing segment fully. To convert the switchable retractor 24 back to the ELR, the facilitator simply allows the webbing segment to fully extract.

In addition, use of the seatbelt components in the seatbelt demonstration kit 10 is shown by combining the various appropriate seatbelt components. For example, the ELR 20 may be combined with either the first locking latch plate 30, the second locking latch plate 32, the sliding latch plate 34, the fixed latch plate 36, or the switchable latch plate to show the various uses of the ELR 20 in combination with the various latch plates 14. In addition, the ALR 26 may be used in combination with the fixed latch plate 36, and the switchable retractor 24 may be used in combination with the sliding latch plate 34 or the fixed latch plate 36.

From the above description, it is clear that the present invention is well adapted to carry out the objects and to attain the advantages mentioned herein as well as those inherent in the invention. While presently preferred embodiments of the invention have been described for purposes of this disclosure, it will be understood that numerous changes may be made which will readily suggest themselves to those skilled in the art and which are accomplished within the spirit of the invention disclosed and claimed.

What is claimed is:

1. A seatbelt kit for demonstrating proper seatbelt component usage to at least one individual, comprising:
at least one retractor;
at least one latch plate;
at least one segment of webbing; and
at least one seatbelt buckle.

2. The seatbelt kit of claim 1 wherein the at least one retractor is a retractor selected from the group consisting of an emergency locking retractor, an automatic locking retractor and a switchable locking retractor.

3. The seatbelt kit of claim 2 wherein the at least one latch plate is a latch plate selected from the group consisting of a locking latch plate, a sliding latch plate, a fixed latch plate and a switchable latch plate.

4. The seatbelt kit of claim 3 wherein the at least one seatbelt buckle is a seatbelt buckle selected from the group consisting of a side-release and top-release, style buckles.

5. The seatbelt kit of claim 4 wherein at least one piece of webbing has a web-stop button.

6. The seatbelt kit of claim 5 further comprising:
a manual for instructing at least one individual on the proper usage of at least one seat belt component provided in the seatbelt demonstration kit.

7. The seatbelt kit of claim 1 wherein the at least one latch plate is a latch plate selected from the group consisting of a locking latch plate, a sliding latch plate, a fixed latch plate and a switchable latch plate.

8. The seatbelt kit of claim 1 wherein the at least one seatbelt buckle is a seatbelt buckle selected from the group consisting of a side-release, top-release, or end-release style buckle.

9. The seatbelt kit of claim 1 wherein at least one piece of webbing has a web-stop button.

10. The seatbelt kit of claim 1 further comprising:
a manual for instructing at least one individual on the proper usage of at least one seatbelt component provided in the seatbelt demonstration kit.

11. A method of educating a person on proper seatbelt usage, comprising the steps of:
providing a seatbelt demonstration kit, comprising:
at least one retractor;
at least one latch plate;
at least one segment of webbing;
at least one seatbelt buckle; and
demonstrating to at least one individual the proper usage of at least one seatbelt component provided in the seatbelt demonstration kit.

12. The method of claim 11 further comprises the steps of:
providing the seatbelt demonstration kit, further comprising:
a manual for instructing at least one individual on the proper usage of at least one seat belt component; and
instructing the at least one individual on the proper usage of seatbelt components.
